(19) United States
(12) Patent Application Publication
(10) Pub. No.: US 2009/0130579 A1
(43) Pub. Date: May 21, 2009

(54) DEVELOPING AGENT AND METHOD FOR MANUFACTURING THE SAME

(75) Inventors: Masahiro Ikuta, Mishima-shi (JP); Takayasu Aoki, Mishima-shi (JP); Takashi Urabe, Sunto-gun (JP); Tsuyoshi Ito, Izunokuni-shi (JP); Yasuhito Noda, Mishima-shi (JP); Motonari Udo, Mishima-shi (JP); Satoshi Araki, Izunokuni-shi (JP); Takafumi Hara, Mishima-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/255,380

(22) Filed: Oct. 21, 2008

Related U.S. Application Data
(60) Provisional application No. 60/988,343, filed on Nov. 15, 2007.

(51) Int. Cl. G03G 9/08; G03G 9/087

(52) U.S. Cl. 430/105; 430/137.14

(57) ABSTRACT

A method for manufacturing a developing agent includes forming a toner particle by adding an aggregating agent to a dispersion containing fine particles containing a binder resin and a colorant to allow aggregation and melt adhesion to occur, wherein the pH of the dispersion satisfies the formula (1) below, when denoting pH before the addition of the aggregating agent by pH(A), the pH of the dispersion after the addition of the aggregating agent by pH(B), and the pH of the dispersion after the melt adhesion by pH(C):

0.90≧pH(C)/pH(A)≧0.25 and 1.00≧pH(C)/pH(B)≧0.30 (1).

### CROSS-REFERENCE TO RELATED APPLICATION

This application is based upon and claims the benefit of priority from U.S. Provisional Application No. 60/988,343, filed Nov. 15, 2007, the entire contents of which are incorporated herein by reference.

### TECHNICAL FIELD

The present invention relates to a developing agent used for electrophotographic technique etc. and a method for manufacturing the same.

### BACKGROUND

Conventionally, as a method for manufacturing a toner in which the form and surface composition of toner particles are intentionally controlled, an aggregation method, in which aggregation-melt adhesion is performed by using a metal salt or a polymer aggregating agent as an aggregating agent for a fine particle dispersion containing at least resin and a colorant, is proposed.

The aggregation method performs the aggregation, as described in JP-A-2001-134017 and JP-A-2003-167380, by setting pH of the dispersion to lower, i.e. a more acidic side than that before the aggregation in the aggregation process, for accelerating the aggregation of fine particles in the dispersion. Then, the aggregation is stopped, and pH is set to a higher, i.e. more basic side than that at the aggregation for preventing coalescence. After that, a melt adhesion process is performed at high temperatures. In the aggregation method, however, since the melt adhesion process and the aggregation-melt adhesion simultaneous process utilize a temperature higher than the glass transition temperature Tg, there is such a problem that the coalescence of melt adhesion particles tends to shift the particle size distribution to form coarse particles. For which, performing redispersion by setting the pH of the dispersion to a basic side or by adding a surfactant for preventing the coalescence leads to such a problem as the generation of fine powder. The problem causes degradation in the image quality.

### SUMMARY

An object of the present invention is to provide a developing agent that can make image quality high and perform melt adhesion at a relatively low temperature because of having good particle size distribution, and a method for manufacturing the same.

The method for manufacturing a developing agent of the invention is a method for manufacturing a developing agent, including forming an aggregated particle by adding an aggregating agent to a dispersion containing fine particles containing a binder resin and a colorant, and forming a toner particle by melt-adhering the aggregated particle, wherein the pH of the dispersion satisfies the formula (1) below, when denoting pH before the addition of the aggregating agent by pH(A), the pH of the dispersion after the addition of the aggregating agent by pH(B), and the pH of the dispersion after the melt adhesion by pH(C):

0.90≧pH(C)/pH(A)≧0.25 and 1.00≧pH(C)/pH(B)≧0.30 (1)

The developing agent of the invention includes a toner particle formed by adding an aggregating agent in a dispersion containing fine particles containing binder resin and a colorant to aggregate and melt-adhere the aggregation, wherein the pH of the dispersion satisfies the formula (1) below, when denoting pH before the addition of the aggregating agent by pH(A), the pH of the dispersion after the addition of the aggregating agent by pH(B), and the pH of the dispersion after the melt adhesion by pH(C):

0.90≧pH(C)/pH(A)≧0.25 and 1.00≧pH(C)/pH(B)≧0.30 (1)

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows a flow diagram exhibiting one embodiment of the method for manufacturing a developing agent of the present invention.

FIG. 2 shows a model view exhibiting the appearance of particles in aggregation and melt adhesion operations when the aggregation and the melt adhesion are performed separately.

FIG. 3 shows a model view exhibiting the appearance of particles in aggregation and melt adhesion operations when the aggregation and the melt adhesion progress simultaneously.

### DETAILED DESCRIPTION

The present invention has, in the method for manufacturing a developing agent by an aggregation method including a process of adding an aggregating agent to a dispersion containing fine particles containing at least a binder resin and a colorant and performing aggregation and melt adhesion, a process of performing the melt adhesion at a prescribed temperature sufficient for the melt adhesion by satisfying the relation shown by the formula (1) below, when denoting pH before the addition of the aggregating agent by pH(A), the pH of the dispersion after the addition of the aggregating agent by pH(B), and the pH of the dispersion after the melt adhesion by pH(C):

0.90≧pH(C)/pH(A)≧0.25 and 1.00≧pH(C)/pH(B)≧0.30 (1).

According to the invention, further performing the melt adhesion is possible after the aggregation by adding an acid or a salt of strong acid-weak base and lowering pH.

According to the invention, by further adding an acid or a salt of strong acid-weak base after the aggregation, before the melt adhesion, or upon performing the aggregation and the melt adhesion in parallel, performing the melt adhesion is possible at a good particle size distribution, and at such relatively low temperature as glass transition temperature Tg+35° C. or less.

When pH(C)/pH(A)>0.90, although no coalescence of aggregated particles occurs, the melt adhesion temperature cannot be reduced to Tg+35° C. or less.

When 0.25>pH(C)/pH(A), although the melt adhesion temperature can be reduced to a prescribed temperature, for example, Tg+35° C. or less, the coalescence of aggregated particles cannot be prevented.

When pH(C)/pH(B)>1.00, although the coalescence of aggregated particles does not occur, the melt adhesion temperature can not be reduced to a prescribed temperature, for example, Tg+35° C. or less.

When 0.30>pH(C)/pH(B), although the melt adhesion temperature can be reduced to a prescribed temperature, for example, Tg+35° C. or less, the coalescence of aggregated particles cannot be prevented.

Further, also when either pH(C)/pH(A) or pH(C)/pH(B) does not satisfy the formula (1), either the coalescence of aggregated particles occurs or the melt adhesion at a prescribed temperature, for example, Tg+35° C. or less can not be performed.

For the aggregation and melt adhesion processes, both performing the aggregation process and the melt adhesion process separately, and performing the aggregation and the melt adhesion in parallel are allowable. When performing the aggregation process and the melt adhesion process separately, it is possible to stop the aggregation process when the aggregated particle becomes sufficiently large, and to move to the melt adhesion process. When performing the aggregation and the melt adhesion in parallel, while repeating the aggregation and melt adhesion, the process can be terminated after performing the melt adhesion when aggregated particles grow to an intended size.

The melt adhesion process is performed at a prescribed temperature, for example, a temperature not more than a temperature higher than the glass transition temperature of the binder resin by 35° C.

When performing the aggregation process and the melt adhesion process separately, the pH adjustment can be performed one or more times at any time before the aggregation, on the way of the aggregation, after the aggregation, or on the way of the melt adhesion.

When performing the aggregation process and the melt adhesion process simultaneously, the pH adjustment can be performed one or more times either before the aggregation-melt adhesion or on the way of the aggregation-melt adhesion.

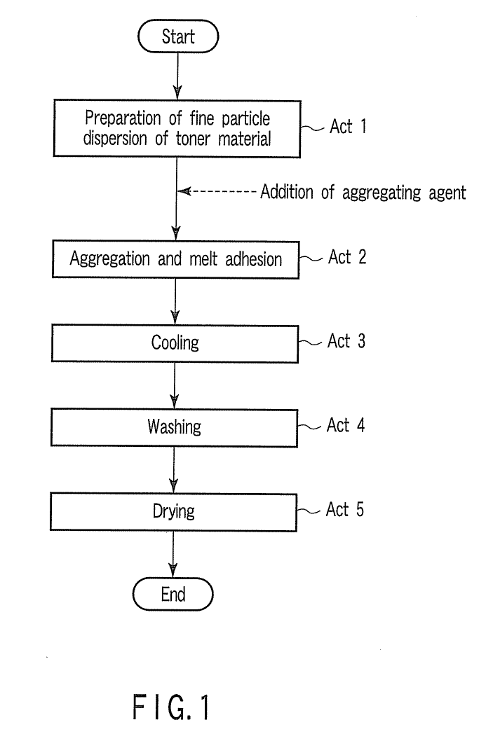

FIG. 1 shows a flow exhibiting one embodiment of the method for manufacturing a developing agent of the invention.

As shown in the drawing, in the invention, firstly a dispersion of fine particles of a toner material is prepared (Act 1).

The fine particle of the toner material contains a colorant and a binder resin.

The fine particle of the toner material arbitrarily contains a mold-releasing agent and a charge control agent, in addition.

Forming the fine particle of the toner material is possible, for example, by previously forming coarse particles and then subjecting the obtained coarse particle to a mechanical shear in a water-based medium. Forming the coarse particle is possible, for example, by melting and kneading a mixture containing a binder resin and a colorant and coarsely pulverizing the same.

Adding, arbitrarily, at least one of a surfactant and a pH adjuster to the water-based medium is possible.

By adding the surfactant, the dispersion in the water-based medium is possible by the surfactant adsorbed on the mixture surface.

Also, by adding a neutralizer, enhancing self-dispersing properties is possible by increasing the dissociation degree or enhancing the polarity of a dissociable functional group on the mixture surface.

Subsequently, forming fine particles is possible by subjecting the obtained mixed liquid to a mechanical shear to granulate the coarse particle further finely.

Performing the mechanical shear is possible under an elevated temperature not less than the glass transition temperature of the binder resin.

According to the invention, finely dividing and granulating coarse particles are possible by applying a mechanical shear force at a temperature not less than the glass transition temperature in a water-based medium.

Controlling the size of fine particles to be obtained is possible by adjusting treatment temperature and treatment time at the mechanical shear, and the rotation number and pressure of a machine that adds the mechanical shear, etc.

After the mechanical shear, the dispersion preferably has a volume average particle diameter of 0.01 to 1.5 μm as a size suitable for forming the developing agent. A size smaller than 0.01 μm tends to make the manufacture of particles difficult, and a size 1.5 μm or greater tends to make the manufacture of particles of 3 to 10 μm difficult. (Act 1)

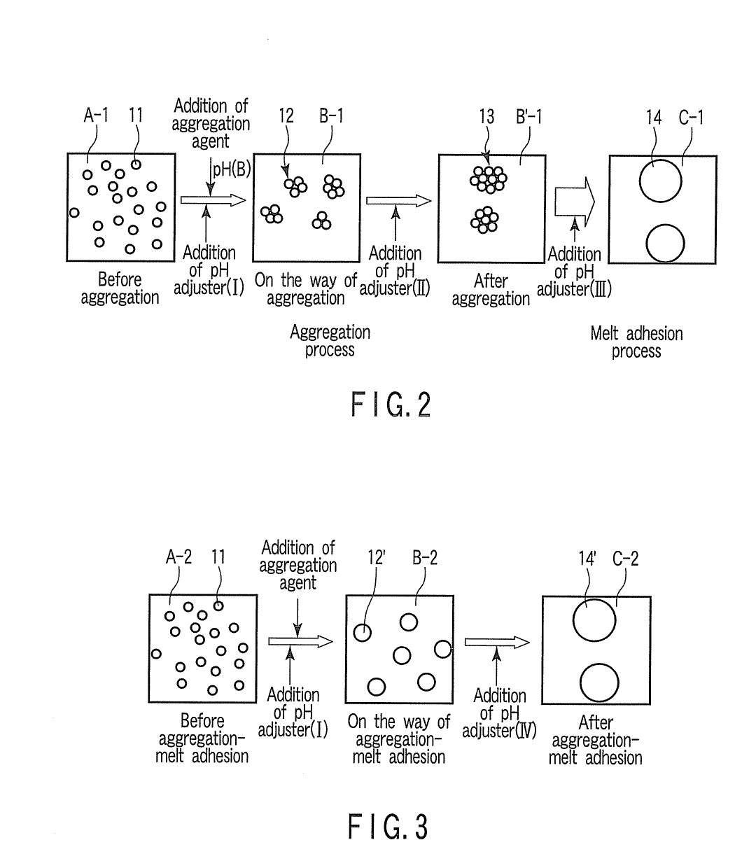

Referring to FIGS. 2 and 3, the example of the aggregation and melt adhesion operations (Act 2) in the invention are further detailed.

FIG. 2 shows a model view exhibiting the appearance of particles in the aggregation and the melt adhesion operations when the aggregation and the melt adhesion are separated.

As shown in the drawing, a dispersion A-1 containing fine particles before adding an aggregating agent has pH of pH(A).

Adding a pH adjuster (I) to the dispersion A-1 before adding the aggregating agent is also possible. The pH adjustment makes it possible to accelerate the aggregation and reduce the melt adhesion temperature to Tg+35° C. or less.

### Aggregation Process

Adding the aggregating agent to the dispersion A-1 makes it change to a dispersion B-1 having pH(B). In the dispersion B-1, fine particles 11 aggregate to form aggregated particles 12. Adding a pH adjuster (II) to the dispersion B-1 is also possible. The pH adjustment makes it possible to accelerate the aggregation and reduce the melt adhesion temperature to Tg+35° C. or less.

When particles 13 having an intended size of, for example, a volume average particle diameter of 3 to 10 μm, additionally adding a pH adjuster (III) is also possible. The pH adjustment makes it possible to reduce the melt adhesion temperature to Tg+35° C. or less.

### Melt Adhesion Process

Then, by heating the dispersion obtained in the above-described aggregation process to a temperature not more than a temperature higher than the glass transition temperature of the binder resin by 35° C., and leaving the same for, for example, 0.5 to 3 hours to perform the melt adhesion, a dispersion C-1 containing melt adhered particles 14 and having pH(C) is obtained.

Adding at least one kind of pH adjusters I, II, III is sufficient. The pH adjusters may be the same or different.

FIG. 3 shows a model view exhibiting the appearance of particles in the aggregation and melt adhesion operations when the aggregation and the melt adhesion progress simultaneously.

As shown in the drawing, the pH of a dispersion A-2 containing fine particles is pH(A) before adding the aggregating agent.

Adding the aggregating agent to the dispersion A-2 makes it change to a dispersion B-2 having pH(B). In the dispersion B-2, fine particles 11 aggregate and melt adhere simultaneously to form aggregated and melt adhered particles 12′. Additionally adding a pH adjuster (IV) to the dispersion B-2 is also possible. The pH adjustment makes it possible to accelerate the aggregation and reduce the melt adhesion temperature to Tg+35° C. or less.

The aggregation melt adhesion is terminated when the particle reaches an intended size, for example, a volume average particle diameter of 3 to 10 μm, to give a dispersion C-2 containing melt adhered particles 14′ and having pH(C).

Adding at least one kind of pH adjusters I and IV is sufficient. The pH adjusters may be the same or different.

By subjecting such dispersion containing melt adhered particles 14 and 14′ to cooling to the glass transition temperature or less (Act 3), and then to washing with, for example, a filter press (Act 4) and drying (Act 5), toner particles are obtained.

As the resin, colorant, mold-releasing agent, surfactant, metal salt, polymer aggregating agent, acid, neutralizer, pH adjuster and mechanical shearing apparatus used in the invention, all the publicly known materials and manufacturing apparatuses can be used.

### Resin Material

Examples of the binder resin used in the invention include styrene-based resins such as polystyrene, styrene-butadiene copolymer, styrene-acrylic copolymer, ethylene-based resins such as polyethylene, polyethylene-vinyl acetate copolymer, polyethylene-norbornene copolymer, polyethylene-vinyl alcohol copolymer, polyester resins, acrylic-based resins, phenol-based resins, epoxy-based resins, allylphthalate-based resins, polyamide-based resins, and maleic acid-based resins. These resins may be used in one kind or in two or more kinds in combination.

The binder resin preferably has the acid value of one or more.

### Colorant

Colorants used in the invention include carbon black, organic or inorganic pigments or dyes, etc. Examples of the carbon black include acetylene black, furnace black, thermal black, channel black, ketjen black, etc. Examples of the yellow pigment include C.I. pigment yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, 185, C.I. bat yellow 1, 3, 20, etc. Using these alone or also in mixture is possible. Examples of the magenta pigment include C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, 238, C.I. pigment violet 19, C.I. bat red 1, 2, 10, 13, 15, 23, 29, 35, etc. Using these alone or also in mixture is possible. Examples of the cyan pigment include C.I. pigment blue 2, 3, 15, 16, 17, C.I. bat blue 6, C.I. acid blue 45, etc. Using these alone or also in mixture is possible.

### Mold-Releasing Agent

Examples of the mold-releasing agent used in the invention include aliphatic hydrocarbon-based waxes such as low molecular weight polyethylene, low molecular weight polypropylene, polyolefin copolymers, polyolefin wax, microcrystalline wax, paraffin wax, Fischer-Tropsch wax, the oxide of aliphatic hydrocarbon-based waxes such as oxidized polyethylene wax or block copolymers thereof, plant-originating waxes such as candelilla wax, carnauba wax, vegetable wax, jojoba wax and rice wax, animal-originating waxes such as bees wax, lanoline and whale wax, mineral-based waxes such as ozokerite, ceresin and petrolatum, waxes containing fatty acid ester as a main component such as montanic acid ester wax and caster wax, and one such as deoxidized carnauba wax obtained by partially or wholly deoxidizing a fatty acid ester. In addition, there are mentioned saturated linear fatty acids such as palmitic acid, stearic acid, montanic acid, or long-chain alkyl carboxylic acids having a longer alkyl group, unsaturated fatty acids such as brassidic acid, eleostearic acid and parinaric acid, saturated alcohols such as stearyl alcohol, eicosyl alcohol, behenyl alcohol, carnaubyl alcohol, ceryl alcohol, melissyl alcohol, or long-chain alkyl alcohols having a longer chain alkyl group, polyhydric alcohols such as sorbitol, fatty acid amides such as linoleamide, oleinamide and laurinamide, saturated fatty acid bisamides such as methylenebisstearamide, ethylenebiscapramide, ethylenebislaurinamide and hexamethylenebisstearamide, unsaturated fatty acid amides such as ethylenebisoleinamide, hexamethylenebisoleinamide, N,N′-dioleyladipamide and N,N′-dioleylcebacamide, aromatic-based bisamides such as m-xylenebisstearamide and N,N′-distearylisophthalamide, fatty acid metal salts (what is generally called metal soap) such as calcium stearate, calcium laurate, zinc stearate and magnesium stearate, wax obtained by grafting an aliphatic hydrocarbon-based wax using a vinyl-based monomer such as styrene and acrylic acid, partial esterified products of a fatty acid such as behenic monoglyceride and a polyhydric alcohol, and methyl ester compounds having a hydroxyl group obtained by hydrogenating vegetable oil.

### Surfactant

Examples of the surfactant usable in the invention include anionic surfactants such as sulfuric acid ester salt-based, sulfonate-based, phosphoric ester-based ones and soap, cationic surfactants of an amine salt type, a quaternary ammonium salt type, etc., and nonionic surfactants such as polyethylene glycol-based, alkylphenolethyleneoxide adduct-based and polyhydric alcohol-based ones.

### Metal Salt

Examples of the metal salt usable for the aggregation process of the invention include salts such as sodium chloride, calcium chloride, calcium nitrate, barium chloride, magnesium chloride, zinc chloride, magnesium sulfate, aluminum chloride, aluminum sulfate, aluminum potassium sulfate, and inorganic metal salt polymers such as polyaluminum chloride, polyaluminum hydroxide and polycalcium sulfide.

### Polymer Aggregating Agent

As the polymer aggregating agent usable for the aggregation process of the invention, there are mentioned such polymer aggregating agents as polymethacrylic ester, polyacrylic ester, polyacrylamide, acrylamide-sodium acrylate copolymer, polyamine, polydiallylammonium halide, polydimethyldiallylammonium halide, melanin-formaldehyde condensate and dicyandiamide.

### Acid

As the acid usable for the aggregation process of the invention, there are mentioned hydrochloric acid, sulfuric acid, nitric acid, perchloric acid, acetic acid, citric acid, etc.

### Neutralizer

Neutralizers usable for the invention include inorganic bases and amine compounds. As the inorganic bases, sodium hydroxide, potassium hydroxide, etc. are mentioned. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane.

### Mechanical Shearing Apparatus

Examples of the mechanical shearing apparatus used in the invention include medialess agitators such as Ultratarax (manufactured by IKA Japan), TK Autohomomixer (manufactured by PRIMIX), TK Pipe Line Homomixer (manufactured by PRIMIX), TK Fillmix (manufactured by PRIMIX), Crea Mix (manufactured by M TECHNIQUE), Crea SS5 (manufactured by M TECHNIQUE), Cabitron (manufactured by Euro Tech) and Fine Flow Mill (manufactured by Pacific Machinery & Engineering), media agitators such as Viscomill (manufactured by Aimex), APEXMILL (manufactured by KOTOBUKI INDUSTRIES), Star Mill (manufactured by Ashizawa Finetech), DCP Super Flow (manufactured by Nippon Eirich), MP Mill (manufactured by INOUE MFG), Spike Mill (manufactured by INOUE MFG), Mighty Mill (manufactured by INOUE MFG) and SC Mill (manufactured by Mitsui Mining), and high pressure impact dispersing machines such as Altimizer (manufactured by SUGINO MACHINE), Nonomizer (manufactured by Yoshida Kikai) and NANO3000 (manufactured by Beryu).

### pH Adjuster

As the pH adjuster used in the invention, there are mentioned, for decreasing pH, acids such as hydrochloric acid, sulfuric acid, nitric acid, perchloric acid, acetic acid and citric acid, and salts of strong acid-weak base such as aluminum sulfate, aluminum chloride, ammonium sulfate and ammonium chloride. For increasing pH, bases such as sodium hydroxide, potassium hydroxide, ammonia and triethylamine are mentioned.

### EXAMPLES

Hereinafter, the present invention is described more specifically, while showing Examples. The property and particle diameter of resin were obtained by methods shown below.

### Measurement of Glass Transition Temperature (Tg)

For the glass transition temperature used in the invention, the measurement was performed using DSC8230 manufactured by Rigaku in the range of 40 to 200° C. with a temperature-increasing rate of 10° C./min. The value at shoulder given by the tangent line method from the DSC curve obtained under the measurement conditions is defined as the glass transition temperature.

### Measurement of Softening Point (Tm)

The softening point used in the invention was given by the flow tester method using CFT-500D manufactured by Shimadzu. While utilizing such measurement conditions as a die: 1.0×1.0 mm, a temperature-increasing rate: 2.5° C./min, a load: 10 kg, a temperature range: 40-200° C. and preheating time: 300 seconds, an efflux-initiating temperature is defined as the softening point.

### Measurement of Particle Size Distribution

In the invention of the application, the particle size distribution of the mixed dispersion of the resin, pigment, and mold-releasing agent was measured with SLAD-7000 manufactured by Shimadzu.

The average particle diameter before the pH adjustment can be measured using an aperture (diameter: 20 μm) of Multisizer 3 manufactured by BECKMAN COULTER. The average toner particle diameter was measured using an aperture (diameter: 100 μm) of Multisizer 3 manufactured by BECKMAN COULTER.

### Manufacturing of Mixed Dispersion 1 of Resin, Pigment and Mold-Releasing Agent

After mixing 90 weight parts of polyester resin (Tg: 62° C., Tm: 115° C.) as the binder resin, 5 weight parts of copper phthalocyanine pigment as the colorant and 5 weight parts of ester wax as the mold-releasing agent, the mixture was melted and kneaded with a twin screw kneader having a temperature set at 120° C. to give a kneaded product.

The obtained kneaded product was coarsely pulverized to have a volume average particle diameter of 1.2 mm with a hammer mill manufactured by NARA MACHINERY to give coarse particles.

Forty weight parts of the coarse particle, 1 weight part of sodium dodecylbenzenesulfonate as an anionic surfactant, 1 weight part of triethylamine as an amine compound, and 59 weight parts of ion-exchanged water were thrown into Crea Mix. After heating the dispersion to 120° C., mechanical agitation was performed for 30 minutes while setting the revolution of the Crea Mix at 6500 rpm, which was then cooled to room temperature to prepare a dispersion having a volume average particle diameter of 480 nm. The obtained dispersion had pH 8.6.

### Manufacturing of Mixed Dispersion 2 of Resin, Pigment and Mold-Releasing Agent

After mixing 90 weight parts of polyester resin (Tg: 62° C., Tm: 115° C.) as the binder resin, 5 weight parts of copper phthalocyanine pigment as the colorant and 5 weight parts of ester wax as the mold-releasing agent, the mixture was melted and kneaded with a twin screw kneader having a temperature set at 120° C. to give a kneaded product.

The obtained kneaded product was coarsely pulverized to have a volume average particle diameter of 1.2 mm with a hammer mill manufactured by NARA MACHINERY to give coarse particles.

The coarse particle was moderately pulverized to have a volume average particle diameter of 0.05 mm with a Bantam mill manufactured by HOSOKAWA Micron to give moderately pulverized particles.

The treatment of 40 weight parts of the moderately pulverized particle, 1 weight part of sodium dodecylbenzenesulfonate as an anionic surfactant, 1 weight part of triethylamine as an amine compound, and 59 weight parts of ion-exchanged water with NANO3000 at 150 MPa and 180° C. prepared a dispersion with a volume average particle diameter of 350 nm. The obtained dispersion had pH 8.5.

### Example 1

### Aggregation—Melt Adhesion Process

To 50 weight parts of the dispersion 1, 30 weight parts of ion-exchanged water was added and mixed. The dispersion at that time had pH(A) 8.5. The addition of 20 weight parts of a 10 wt % aqueous sodium chloride solution as a metal salt at room temperature gave pH(B) 8.3. Subsequently, the dispersion was heated to 75° C., to which hydrochloric acid was added when the volume average particle diameter became 2.4 μm to adjust to pH 3.0, which was then left at 75° C. for 2 hours for controlling the particle diameter and form. The obtained post-melt adhesion dispersion had pH(C) 3.0.

### Washing and Drying Process

After cooling, the solid content of the obtained dispersion was repeatedly subjected to centrifugation using a centrifuge, removal of supernatant and washing with ion-exchanged water, until the supernatant gave an electric conductivity of 50 μS/cm. After that, the product was dried until the moisture content became 0.3 wt % with a vacuum dryer to give toner particles.

After the drying, 2 weight parts of hydrophobic silica and 0.5 weight part of titanium oxide were adhered to the toner particle surface as additives to give a toner.

The obtained toner had a volume average particle diameter of 5.32 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 4.5%.

Further, the result of evaluating image quality by throwing the obtained toner into a copier, e-STUDIO 281c manufactured by TOSHIBA TEC and modified for evaluation gave good image quality.

### Example 2

### Aggregation Process

To 50 weight parts of the dispersion 2, 30 weight parts of ion-exchanged water was added and mixed. pH(A) was 8.4. The addition of 20 weight parts of a 20 wt % aqueous sodium chloride solution as a metal salt at room temperature gave pH(B) 8.3. Subsequently, the dispersion was heated to 60° C., to which sulfuric acid was added when the volume average particle diameter became 1.9 μm to adjust to pH 4.0, which was then heated to 65° C.

### Melt Adhesion Process

For maintaining the volume average particle diameter of the aggregated particles, 3 weight parts of sodium dodecylbenzenesulfonate was added as a dispersant, which was heated to 80° C. and left for 2 hours for controlling the form. The obtained post-melt adhesion dispersion had pH(C) 4.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.86 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 6.1%.

Further, the result of evaluating image quality by throwing the obtained toner into a copier, e-STUDIO 281c manufactured by TOSHIBA TEC and modified for evaluation gave good image quality.

### Example 3

### Aggregation Process

To 50 weight parts of the dispersion 1, 30 weight parts of ion-exchanged water was added and mixed. pH(A) was 8.5. The addition of 20 weight parts of a 20 wt % aqueous sodium chloride solution as a metal salt at room temperature gave pH(B) 8.2. Subsequently, the dispersion was heated to 65° C.

### Melt Adhesion Process

For maintaining the volume average particle diameter of the aggregated particles, 3 weight parts of sodium dodecylbenzenesulfonate was added as a dispersant, which was heated to 85° C., adjusted to pH 5.5 with hydrochloric acid and left for 2 hours for controlling the form. The obtained post-melt adhesion dispersion had pH(C) 5.5.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.93 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 5.8%.

Further, the result of evaluating image quality by throwing the obtained toner into a copier, e-STUDIO 281c manufactured by TOSHIBA TEC and modified for evaluation gave good image quality.

### Example 4

### Aggregation-Melt Adhesion Process

To 25 weight parts of the dispersion 1, 55 weight parts of ion-exchanged water was added and mixed. pH(A) was 8.4. The addition of 10 weight parts of a 10 wt % aqueous sodium chloride solution as a metal salt and 10 weight parts of 5 wt % polydimethyldiallylammonium chloride as a polymer aggregating agent at room temperature gave pH(B) 6.8. Subsequently, the dispersion was heated to 90° C., which was adjusted to pH 6.0 by adding hydrochloric acid, and then left for 2 hours, while allowing the aggregation-melt adhesion to progress simultaneously, for controlling the particle diameter and form. The obtained post-melt adhesion dispersion had pH(C) 6.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.98 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 6.8%.

Further, the result of evaluating image quality by throwing the obtained toner into a copier, e-STUDIO 281c manufactured by TOSHIBA TEC and modified for evaluation gave good image quality.

### Example 5

### Aggregation Process

To 25 weight parts of the dispersion 1, 55 weight parts of ion-exchanged water was added and mixed. pH(A) was 8.4. After adjusting to pH 7.5 by adding hydrochloric acid, 20 weight parts of a 1 wt % aqueous aluminum sulfate solution was added as a metal salt at room temperature to give pH(B) 6.5. Subsequently, the temperature was increased to 50° C.

### Melt Adhesion Process

For maintaining the volume average particle diameter of the aggregated particles, 5 weight parts of sodium dodecylbenzenesulfonate was added as a dispersant, which was heated to 90° C. and left for 3 hours for controlling the form. The obtained post-melt adhesion dispersion had pH(C) 6.5.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 5.06 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 8.7%.

Further, the result of evaluating image quality by throwing the obtained toner into a copier, e-STUDIO 281c manufactured by TOSHIBA TEC and modified for evaluation gave good image quality.

### Example 6

### Aggregation Process

To 25 weight parts of the dispersion 1, 55 weight parts of ion-exchanged water was added and mixed. pH(A) was 8.4. The addition of 20 weight parts of a 1 wt % aqueous aluminum sulfate solution gave pH(B) 7.0. Subsequently, the dispersion was heated to 55° C.

### Melt Adhesion Process

For maintaining the volume average particle diameter of the aggregated particles, 5 weight parts of sodium dodecylbenzenesulfonate was added as a dispersant, which was adjusted to pH 5.0 by adding hydrochloric acid, heated to 90° C. and left for 2 hours for controlling the form. The obtained post-melt adhesion dispersion had pH(C) 5.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give a toner.

The obtained toner had a volume average particle diameter of 5.26 μm.

Table 1 below shows the result.

The measurement of toner particle size distribution using an aperture (diameter: 20 μm) of Multisizer 3 manufactured by BECKMAN COULTER gave such good result that particles having a volume particle diameter of 2 μm or less were 9.7%.

Further, the result of evaluating image quality by throwing the obtained toner into a copier, e-STUDIO 281c manufactured by TOSHIBA TEC and modified for evaluation gave good image quality.

### Comparative Example 1

### Aggregation-Melt Adhesion Process

To 50 weight parts of the dispersion 1, 30 weight parts of ion-exchanged water was added and mixed. pH(A) was 8.5. The addition of 20 weight parts of a 15 wt % aqueous sodium chloride solution as a metal salt at room temperature gave pH(B) 8.2. Subsequently, the dispersion was heated to 100° C., which was left, while allowing the aggregation and the melt adhesion to progress simultaneously, for 3 hours for controlling the form. After the completion of the heat adhesion, the pH(C) of the dispersion was 8.2.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.83 μm.

Table 1 below shows the result.

The measurement of toner particle size distribution using an aperture (diameter: 20 μm) of Multisizer 3 manufactured by BECKMAN COULTER gave such result that particles having a volume particle diameter of 2 μm or less were 12.5%.

Further, the result of evaluating image quality by throwing the obtained toner into a copier, e-STUDIO 281c manufactured by TOSHIBA TEC and modified for evaluation resulted in a result of degraded image quality.

### Comparative Example 2

### Aggregation Process

To 25 weight parts of the dispersion 1, 55 weight parts of ion-exchanged water was added and mixed. pH(A) was 8.5. The addition of 20 weight parts of a 1 wt % aqueous aluminum sulfate solution as a metal salt at room temperature gave pH(B) 7.1. Subsequently, the dispersion was heated to 55° C.

### Melt Adhesion Process

For maintaining the volume average particle diameter of the aggregated particles, 5 weight parts of sodium dodecylbenzenesulfonate was added as a dispersant, which was heated to 98° C. and left for 3 hours for controlling the form. The obtained post-melt adhesion dispersion had pH(C) 8.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.96 μm.

Table 1 below shows the result.

The measurement of toner particle size distribution using an aperture (diameter: 20 μm) of Multisizer 3 manufactured by BECKMAN COULTER gave such result that particles having a volume particle diameter of 2 μm or less were 13.8%.

Further, the result of evaluating image quality by throwing the obtained toner into a copier, e-STUDIO 281c manufactured by TOSHIBA TEC and modified for evaluation resulted in a result of degraded image quality.

### Comparative Example 3

### Aggregation-Melt Adhesion Process

To 25 weight parts of the dispersion 1, 55 weight parts of ion-exchanged water was added and mixed. pH(A) was 8.5. The addition of 10 weight parts of a 10 wt % aqueous sodium chloride solution as a metal salt and 10 weight parts of 5 wt % polydimethyldiallylammonium chloride as a polymer aggregating agent at room temperature gave pH(B) 6.8. Subsequently, the dispersion was heated to 100° C., which was left, while allowing the aggregation and the melt adhesion to progress simultaneously, for 2 hours for controlling the particle diameter and form. After the completion of the heat adhesion, the pH(C) of the dispersion was 7.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 4.74 μm.

Table 1 below shows the result.

The measurement of toner particle size distribution using an aperture (diameter: 20 μm) of Multisizer 3 manufactured by BECKMAN COULTER gave such result that particles having a volume particle diameter of 2 μm or less were 11.7%.

Further, the result of evaluating image quality by throwing the obtained toner into a copier, e-STUDIO 281c manufactured by TOSHIBA TEC and modified for evaluation resulted in a result of degraded image quality.

### Comparative Example 4

### Aggregation Process

To 50 weight parts of the dispersion 1, 30 weight parts of ion-exchanged water was added and mixed. The pH(A) of the obtained dispersion was 8.5. The addition of 20 weight parts of a 20 wt % aqueous sodium chloride solution as a metal salt at room temperature gave pH(B) 8.2. Subsequently, the dispersion was heated to 60° C., to which sulfuric acid was added when the volume average particle diameter became 2.3 μm to adjust to pH 2.0, which was then heated to 65° C.

### Melt Adhesion Process

To the aggregated particles, 3 weight parts of sodium dodecylbenzenesulfonate was added as a dispersant, which was heated to 75° C. and left for 1.5 hours for controlling the form. After the completion of the heat adhesion, the pH(C) of the dispersion was 2.0.

### Washing and Drying Process

After cooling, the obtained dispersion was washed with a centrifuge in the same way as in Example 1, which was dried until the moisture content became 0.3 wt % with a vacuum dryer to give toner particles.

After drying, 2 weight parts of hydrophobic silica and 0.5 weight part of titanium oxide were adhered to the toner particle surface as additives to give an intended toner.

The obtained toner had a volume average particle diameter of 13.8 μm.

Table 1 below shows the result.

Making the particle diameter fall within 3-10 μm was unsuccessful.

Further, the result of evaluating image quality by throwing the obtained toner into a copier, e-STUDIO 281c manufactured by TOSHIBA TEC and modified for evaluation resulted in a result of degraded image quality.

By employing such constitution, it is possible to reduce the melt adhesion temperature of a binder resin to a temperature not more than a temperature higher than Tg by 35° C.

TABLE 1

| | | Polymer | | | | | | | |
|---|---|---|---|---|---|---|---|---|---|
| | Aggregating | aggregating | Aggregation melt | | | | | | pH(C)/ |
| | agent | agent | adhesion method | pH adjuster | pH adjusting time | pH(A) | pH(B) | pH(C) | pH(A) |
| Ex. 1 | sodium | none | simultaneously | hydrochloric | on the way of | 8.5 | 8.3 | 3.0 | 0.35 |
| | chloride | | | acid | aggregation - melt | | | | |
| | | | | | adhesion | | | | |
| Ex. 2 | sodium | none | separately | sulfuric acid | on the way of | 8.4 | 8.3 | 4.0 | 0.48 |
| | chloride | | | | aggregation | | | | |
| Ex. 3 | sodium | none | separately | hydrochloric | on the way of | 8.5 | 8.2 | 5.5 | 0.65 |
| | chloride | | | acid | melt adhesion | | | | |
| Ex. 4 | sodium | polydimethyldiallyl- | simultaneously | hydrochloric | on the way of | 8.4 | 6.7 | 6.0 | 0.71 |
| | chloride | ammonium chloride | | acid | aggregation - melt | | | | |
| | | | | | adhesion | | | | |
| Ex. 5 | aluminum | none | separately | hydrochloric | before | 8.4 | 6.5 | 6.5 | 0.77 |
| | sulfate | | | acid | aggregation | | | | |
| Ex. 6 | aluminum | none | separately | hydrochloric | after | 8.4 | 7.0 | 5.0 | 0.60 |
| | sulfate | | | acid | aggregation | | | | |
| Comp. | sodium | none | simultaneously | none | none | 8.5 | 8.2 | 8.2 | 0.96 |
| Ex. 1 | chloride | | | | | | | | |
| Comp. | aluminum | none | separately | none | none | 8.5 | 7.1 | 8.0 | 0.94 |
| Ex. 2 | sulfate | | | | | | | | |
| Comp. | sodium | polydimethyldiallyl- | simultaneously | none | none | 8.5 | 6.8 | 7.0 | 0.82 |
| Ex. 3 | chloride | ammonium chloride | | | | | | | |
| Comp. | sodium | none | separately | hydrochloric | on the way of | 8.5 | 8.2 | 2.0 | 0.24 |
| Ex. 4 | chloride | | | acid | aggregation | | | | |

| | | | | Toner | | |
|---|---|---|---|---|---|---|
| | | Melt | Average particle | average | | |
| | | adhesion | diameter before | particle | | |
| | pH(C)/ | temperature | pH adjustment | diameter | Particle | Image |
| | pH(B) | (° C.) | (μm) | (μm) | distribution | quality |
| Ex. 1 | 0.36 | 75 | 2.35 | 5.32 | ∘ | ∘ |
| Ex. 2 | 0.48 | 80 | 1.92 | 4.86 | ∘ | ∘ |
| Ex. 3 | 0.67 | 85 | 3.14 | 4.93 | ∘ | ∘ |
| Ex. 4 | 0.90 | 90 | 1.57 | 4.98 | ∘ | ∘ |
| Ex. 5 | 1.00 | 90 | 0.87 | 5.06 | ∘ | ∘ |
| Ex. 6 | 0.71 | 85 | 4.73 | 5.26 | ∘ | ∘ |
| Comp. | 1.00 | 100 | | 4.83 | x | x |
| Ex. 1 | | | | | | |
| Comp. | 1.13 | 98 | | 4.96 | x | x |
| Ex. 2 | | | | | | |
| Comp. | 1.03 | 100 | | 4.74 | x | x |
| Ex. 3 | | | | | | |
| Comp. | 0.24 | 75 | 2.36 | 13.8 | x | x |
| Ex. 4 | | | | | | |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for manufacturing a developing agent, comprising forming a toner particle by adding an aggregating agent to a dispersion containing fine particles containing a binder resin and a colorant to allow aggregation and melt adhesion to occur,
wherein the pH of the dispersion satisfies the formula (1) below, when denoting pH before the addition of the aggregating agent by pH(A), the pH of the dispersion after the addition of the aggregating agent by pH(B), and the pH of the dispersion after the melt adhesion by pH(C):
0.90≧pH(C)/pH(A)≧0.25 and 1.00≧pH(C)/pH(B)≧0.30 (1)

2. The method according to claim 1 comprising adding a pH adjuster to the dispersion at least once.

3. The method according to claim 1 performing the aggregation and the melt adhesion of the fine particles separately or in parallel.

4. The method according to claim 1 performing the melt adhesion of fine particles at a temperature not more than a temperature higher than the glass transition temperature of the binder resin by 35° C.

5. The method according to claim 1 employing at least one of a metal salt, a polymer aggregating agent and an acid as the aggregating agent.

6. The method according to claim 1, wherein the glass transition temperature Tg of the binder resin, the softening point Tm thereof and the melt adhesion temperature t of the developing agent satisfy the formula (2) below:
Tg<t<Tm (2)

7. A developing agent comprising a toner particle formed by adding an aggregating agent to a dispersion containing fine particles containing a binder resin and a colorant to allow aggregation and melt adhesion to occur,
wherein the pH of the dispersion satisfies the formula (1) below, when denoting pH before the addition of the aggregating agent by pH(A), the pH of the dispersion after the addition of the aggregating agent by pH(B), and the pH of the dispersion after the melt adhesion by pH(C):
0.90≧pH(C)/pH(A)≧0.25 and 1.00≧pH(C)/pH(B)≧0.30 (1)

8. The developing agent according to claim 7 comprising adding a pH adjuster to the dispersion at least once.

9. The developing agent according to claim 7 performing the aggregation and the melt adhesion of the fine particles separately or in parallel.

10. The developing agent according to claim 7 performing the melt adhesion of the fine particles at a temperature not more than a temperature higher than the glass transition temperature of the binder resin by 35° C.

11. The developing agent according to claim 7 employing at least one of a metal salt, a polymer aggregating agent and an acid as the aggregating agent.

12. The developing agent according to claim 7, wherein the glass transition temperature Tg of the binder resin, the softening point Tm thereof and the melt adhesion temperature t of the developing agent satisfy the formula (2) below:
Tg<t<Tm (2).
